(19) United States
(12) Patent Application Publication
(10) Pub. No.: US 2013/0335206 A1
(43) Pub. Date: Dec. 19, 2013

(54) MODULE FOR MANAGING LAMPPOSTS AND SERVICES, AND TELEMANAGEMENT SYSTEM COMPRISING AT LEAST ONE SUCH MODULE

(71) Applicants: Nicolas Braud, Boulogne-Billancourt (FR); Jean-Michel Guery, Le Vesinet (FR)

(72) Inventors: Nicolas Braud, Boulogne-Billancourt (FR); Jean-Michel Guery, Le Vesinet (FR)

(21) Appl. No.: 13/812,132

(22) PCT Filed: Jul. 26, 2010
(86) PCT No.: PCT/EP10/60798

§ 371 Date: Aug. 28, 2013

(30) Foreign Application Priority Data
Jul. 27, 2009 (FR) 0955232

(51) Int. Cl. H04B 3/54

(52) U.S. Cl. CPC H04B 3/54
USPC 340/12.32

(57) ABSTRACT

The invention relates to a module for managing the lighting of a lamppost, placed on the power supply network of a set of lampposts and controlled by a command centre. Said module communicates with the command centre by high-speed power line carrier (PLC) and is able to ensure the management of at least one complementary service. The invention also relates to a telemanagement system for public lighting, comprising a command centre for a set of lampposts and at least one such management module, said module communicating with said command centre by high-speed power line carrier (PLC).

### FIELD OF THE INVENTION

The present invention relates to the field of lighting networks.

In particular it proposes modules for managing lampposts and services connected to a control center through an electric power supply network.

It also proposes a telemanagement system comprising a control center and one or several modules for managing lampposts and services connected to said control center through the electric power supply network.

### BACKGROUND OF THE INVENTION

Telemanagement of public lighting (urban communities, private sectors) is a technical field in full development.

Notably, the intention of obtaining energy savings on the public lighting network and of reducing the cost of the latter leads to seeking solutions for optimizing the consumed electric power by the lampposts.

Telemanagement systems are known which allow control of public lighting by a low throughput power line carrier current.

Moreover, the development of novel remote monitoring technologies, of remote reading of meters, of Wifi terminals in cities, etc., makes it necessary to have availability of adequate supports in the urban environment.

As the lampposts form a relatively regular group of an urban area, it therefore seems to be interesting to use them as a support for these novel pieces of equipment. From document WO 96/36202, a public lighting telemanagement device is already known with communication through a carrier current with phase modulation and a frequency of 132 kHz, between a central station on the one hand and devices which are associated with lampposts and which control their lighting lamps, on the other hand.

This document by no means makes provision for associating additional services to the lighting telemanagement system, on the contrary, such a system using transmission through a phase modulated carrier current at a frequency of 132 kHz is hardly compatible with the application on this same network of data exchanges with the IP format. The application of additional services would therefore assume a distinct power supply and information transmission network and therefore additional civil engineering work operations.

Document FR 2 888 068, as for it, proposes the use of lampposts connected as a cluster to a same power supply cabinet in order to form a communicating network and to provide said lighting masts with a certain number of services. For this purpose, the masts of the lamppost are equipped with router switches. The function of these router switches is to ensure transmission of binary data between a wired power line carrier (PLC) network made by using the electric power supply network of the masts on the one hand and various pieces of equipment on the other hand which are located in proximity to the lampposts and which communicate through a wireless technology with these router switches.

However it will be noted that in such a system, the power supply cabinet has to maintain the lampposts lit up so that the services which are associated with their masts may operate. Continuous operation of the services therefore causes permanent switching on of public lighting.

Moreover, it will be noted that this document proposes for the PLC technology, the use of the home plug standard, which for the moment has been essentially developed for (“indoor”) installations of the apartment or house type, i.e. for small distances, without any function for repeating the signal in order to deal with the distance to be covered on public lighting, and with a non-leakproof technology.

An object of the invention is to provide a solution for telemanagement of lampposts, which may be used as a support for a large diversity of pieces of equipment and of services.

Another object of the invention is to propose an easy and inexpensive solution to be installed, while allowing independent management of the lighting on the one hand and of the service equipment associated with the lampposts and installed on the same electric network on the other hand (switching the lighting on/off, but also dimming of the lighting, programming, consumption report, detection of failures and sending of alerts, etc.,).

Another further object of the invention is to propose a solution which allows pieces of equipment to be very easily moved from one lamppost to the other, in order to reconfigure an area on which a given service is deployed. Another further object is to propose a solution which allows transmission of information in a secured way between the lampposts and the pieces of service equipment deployed and remote providers/users.

### SHORT DESCRIPTION OF THE INVENTION

The invention notably proposes a module for managing lampposts connected to an electric power supply network, said module including electronics which comprises a power line carrier injector/receiver through which it is connected to the electric network and which allows it to communicate with a control center notably for receiving instructions for switching on/off the lamppost.

Said module has the particularity of being able to also ensure management of at least one additional service such as video protection, sound system, Wifi band, electric vehicle recharging terminal, etc.

The management which it ensures for the lamppost on the one hand and that which it ensures for the complementary service(s) are independent, said module including for this purpose:
at least two outputs able to supply power independently to the lantern(s) of the lampposts and at least one piece of service equipment associated with the lamppost,
at least one port for connecting a computer cable, between this piece of equipment and said module,

the electronics being positioned in a casing and including:
means able to independently control the power supply outputs according to instructions transmitted through a carrier current by the control center, means for processing and/or transmitting data connected to the port on the one hand to the carrier current injector/receiver, the carrier current injector/receiver being of the high throughput type.

It is understood that such a module allows both telemanagement of a lighting of the public lighting type and the integration of different additional services. The public lighting and the services are, by means of such a module, managed in a differentiated way, notably in terms of extinction/programming. In particular, this allows savings of energy, as well as improvement in the lifetimes of the pieces of equipment.

The setting up of such a module is further particularly easy and inexpensive. Its installation does not require any civil engineering work operations.

Advantageously, the electronics may include:
a PLC injector/receiver motherboard which includes the means for processing and transmitting data and which is connected to the port for connecting the computer cable and
a daughterboard which includes means able to control the power supply outputs, said daughterboard conversing with the PLC injector/receiver motherboard.

The module may, as for it, include, added onto the casing:
first set of connections for a cable able to ensure connection with the circuit-breaker of the lamppost,
a power supply set for a cable integrating at least two sheaths with two wires for independently powering the lantern(s) of the lamppost and a piece of service equipment,
a set of connections for an Ethernet connector cable.

These sets of connections contribute to allowing an easy and changeable installation.

Preferentially, the electronics includes means for generating at least one output voltage for controlling the dimming of the lantern of a lamppost. Notably, the power supply set of connections is able to receive a cable integrating, in addition to the sheaths with power supply wires, at least one sheath with two wires receiving the dimming control voltage.

The electronics of the module may further include means for filtering EMC perturbations potentially generated by the ballasts of the lampposts. In this way, possible perturbation problems from the high throughput due to high frequencies of the ballasts of the lampposts are solved.

Also advantageously, the electronics may include means for measuring the individual consumption of the lantern(s) of the lamppost and/or of an associated piece of service equipment. Notably, the means for processing and transmitting data for example include means for processing measured individual consumptions and thus facilitating billing of the services to the users/providers according to their actual consumption. They also include means allowing generation of an alert signal intended for the control center or directly to the users when an abnormality in the operation of the lantern(s), of a piece of service equipment and/or of the electric network is detected.

The invention also proposes a system for telemanagement of public lighting, characterized in that it comprises a control center for a set of lampposts and at least one management module installed in, on or in proximity to a lamppost and able to ensure independent management of the lighting of the lamppost and of at least one additional service, said module communicating with the control center through a high throughput power line carrier.

Notably, the control center may exchange with a remote control unit of the network, with which it is possible to avoid information overloads. Said control unit includes means for securely transmitting IP data towards providers/users of services.

In a particularly advantageous way, the control center is able to detect the connection of a new piece of service equipment on a module and includes means for querying said piece of equipment upon such a connection and transmitting to a control unit identification data, compared by the control unit with data stored in memory in a database, in order to allow authentication of said piece of equipment and thus secure accesses.

### SHORT DESCRIPTION OF THE DRAWINGS

Other features and advantages of the invention will become apparent from the detailed description which follows, with reference to the appended figures given as non-limiting and wherein:

FIG. 1 illustrates a telemanagement system according to an embodiment of the invention, with at least one management module integrated into a lamppost,

FIG. 2 is a schematic perspective illustration of the casing and of the set of connections of a management module according to an embodiment of the invention,

FIG. 3 is a sectional view of the management module of FIG. 2, and

FIG. 4 is a block diagram of the management module of FIGS. 2 and 3.

### DETAILED DESCRIPTION OF THE INVENTION

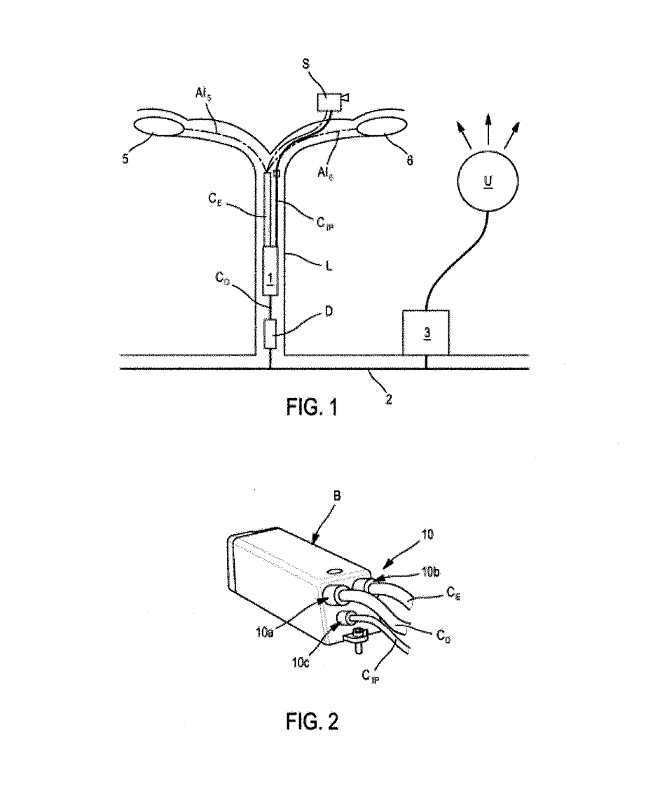

A lamppost L is illustrated in FIG. 1, including a circuit breaker D connected, with other similar lampposts L (not shown), to a control and power supply cabinet 3 through an electric power supply network 2.

Inside the lamppost, on the latter (for example at the foot of said lamppost L) or in close proximity thereto, a management module 1 is installed, which is connected to the electric power supply network 2 by connection with the circuit breaker D. The ballasts of the different lanterns 5, 6 of the lamppost L (in this case two in number), as well as one or several pieces of service equipment (in the example shown, a camera S) are, as for them, connected to this module 1 through different cables.

As illustrated by FIGS. 2 to 4, the module 1 appears as a casing B integrating different sets of connections 10.

In this case, the casing B integrates a set 10a of connections allowing its connection, by means of a power supply cable C_{D} with two wires, to the circuit-breaker D.

It also includes a set 10b of connections for connecting a cable C_{E} itself integrating several pairs of cables. For example, this cable C_{E} may integrate at least five sheaths with wire pairs, respectively dedicated to:
the electric power supply of the first lantern 5 (ON/OFF control of the latter) (sheath Al5),
the electric power supply of the second lantern 6 (ON/OFF control of the latter) (sheath Al6),
the dimming of the lighting of the first lamppost 5 (dimming 1-10 V) (sheath GRADS),
the dimming of the lighting of the second lamppost 6 (dimming 1-10 V) (sheath GRADE), and the electric power supply of the piece of service equipment S (ON/OFF control of this piece of equipment) (sheath AlS).

Alternatively, a single pair of wires may be used for powering/extinguishing and/or dimming the lighting of both lanterns.

The casing B also includes a separate set 10c of connections for a computer connection, typically for connecting an Ethernet cable CP provided with an RJ45 or RS 232 plug.

The casing B is a leakproof casing. Its dimensions are adapted so as to allow the module 1 to be inserted into the mast of the lamppost L, and attached to the mast via attachment means such as hooks and/or a system of screws and nuts.

Typically, on the outside, the casing has a length (including attachment tabs) of less than 500 mm, as well as a width (overall width) and a height (overall height) of less than 100 mm, for example 274 mm×64 mm×64 mm.

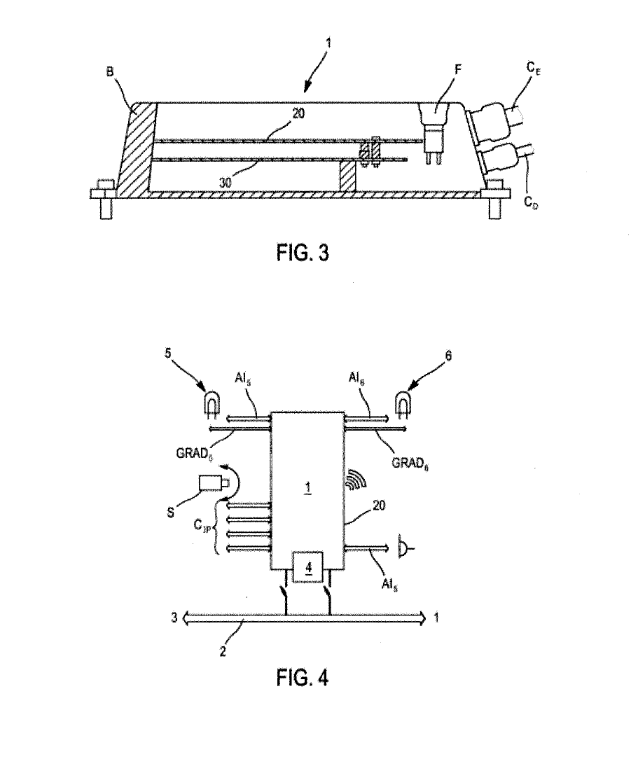

The electronics inside the casing B includes a motherboard 20 (FIG. 3) adapted for allowing communication between the module 1 and the control center 3 through a PLC power line carrier current with high throughput 4 which allows it to decode the signal received via the electric network 2.

The PLC technology generally consists of transmitting information by means of the electric current.

These pieces of information are superposed to the 220V electric current (for which the frequency 30 is 50 or 60 Hz) as a signal of higher frequency and of low energy.

In the case of low throughput PLC, frequency modulation techniques are used over a band comprised between 9 and 150 kHz (in Europe). For the high throughput PLC, multicarrier modulations are used in a band from 1.6 to 30 MHz.

Said module 1, as for it, operates with high throughput and is therefore suitable for services such as video protection, sound system, Wifi band, electric vehicle recharging terminal, and where high throughput has significant advantages as compared with the radio network, notably for video.

The basic components of the PLC network are:
PLC injector which produces the superposition of information on the electric current, thereby allowing propagation of the signal on the electric network;
a PLC receiver located on said electric network, and equipped with a coupler which allows suppression of the low frequency components and processing of the high frequency signals.

The PLC receiver may be a PLC repeater/receiver, for example a component provided by the DS2 corporation based on a PLC protocol selectively operating between 2 and 34 MHz.

The motherboard 20 includes an injector/repeater/receiver of this type as well as an Ethernet port corresponding to the set 10c of connections.

It is associated with a daughterboard 30 which controls the different ON/OFF power supplies of the lantern(s) of the lamppost as well as of the piece(s) of service equipment associated with the latter. It further controls the dimming 1-10V of the ballast of the lanterns.

Moreover it includes metrology means which allow it to measure the individual consumptions of the different lanterns and of the different pieces of service equipment.

This daughterboard 30 converses with the motherboard 20 to which it is connected and from which it notably receives controls for powering and dimming the lighting as well as for powering the service equipment.

It itself transmits to the motherboard 20, information intended to be sent back to the control center formed by the power supply carrier 3 to which the module 1 is connected (report on the individual consumptions of the lanterns or of the pieces of service equipment, data flows from the latter, etc., . . . ), these pieces of information being themselves being sent back if necessary by the conventional internet connection means, onto a remote control unit U of the network (FIG. 1), which itself will process these pieces of information and will transmit them to different addressees (for purposes of billing the services or the electric consumptions, for example). The control unit U further gives the possibility of avoiding any overload of information at the processing server of the control center 3.

The daughterboard 30 or the motherboard 20 are further adapted for evaluation the condition of the lamps and pieces of equipment.

For this purpose, the daughterboard 30 (or the motherboard 20) compares the measured consumption values with expected theoretical consumptions, and sends alert messages to the control center 3 if the measured consumption differs from the expected theoretical consumption.

Alerts are then sent to the control center 3 which itself retransmits them to the central unit U on the one hand, and from this central unit U on the other hand, to the different relevant providers, preferably in an SNMP language.

Also, the daughterboard 30 includes in close proximity to the set 10b of connections, a circuit F for filtering EMCs. This circuit is intended to limit the perturbations of the PLC signals which may be generated by the ballast of the lamps.

It is understood that such a module 1 is particularly easily set up by a system of the “plug & play” type. It is sufficient to connect its power supply set 10a of connections to the circuit-breaker D of the lamppost L, to connect the power supply and dimming inputs of the ballast of the different lanterns to a cable of the EC cable type with five sheaths of wire pairs, itself connected to the set 10b of connections and finally to connect an Ethernet cable of the piece of service equipment S to the plug of an IP cable connected to the set 10c of connections.

With such a module 1, the lanterns of the lamppost L and its piece(s) of service equipment (camera S) are controlled and powered in a totally independent way.

Therefore, it becomes possible to power them separately, according to distinct timetables notably according to whether the associated service is in real time (video surveillance, etc.) or uncorrelated (lighting, tourist information terminal, etc.).

The switching on/off instructions are passed on to the module 1 by the control center 3, either on an ad hoc basis, or in the form of a timetable which is transmitted to the module 1 by the control center 3 and stored in a memory of the module 1. This latter mode gives the possibility of making up for possible failures of the data network.

The timetable includes, for a given time period (for example a few days), the schedules for switching on and off the lampposts with possible dimming. These schedules may vary depending on the moment of the week (working day or official holiday), on the season, but also depending on foreseen events (for example, a large night crowd on the occasion of a sporting event).

At regular intervals (for example every minute), the module searches in the timetable for the state (or billing level) in which it should be. If the state is different from that of the module, a new billing command is then sent.

If after a certain time (for example several days), the billing state has not changed, the module 1 sends an alert to the control center 3.

It will be noted that the power supply cabinet or control center 3 includes on its side, a central server which stores in memory the different timetables for switching ON/OFF the lampposts of the network and which passes them on to the corresponding management modules via the high throughput power line carrier current.

For these exchanges with the modules 1, such a control center is equipped with a high throughput PLC injector/repeater/receiver which allows superposition of the signal onto the electric current. This is for example a standard PLC injector equipped with a 9002 or 9503 microprocessor from DS2.

It will further be noted that each module 1 may be authenticated by querying by the control center 3 upon its setting up in or on a lamppost L.

Also, each of the pieces of service equipment S which may be used on the network 2, is declared in a database which may be queried by the external unit U. When the control center 3 detects the connection of piece of equipment S, it queries this equipment so that it provides a piece of information for individual identification. The thereby recovered data are compared by the control center 3 and the unit U for authenticating the piece of equipment S by comparison with the contents of the database.

Moreover, it is known that the networks of the different electric cabinets (or control centers 3) are conventionally connected together through a safety network which give the possibility of maintaining a power supply, even in the case of the cutting off of the main power supply of one of the cabinets 3. This infrastructure already in place may be used for reconfiguring the clusters of lampposts L depending on a cabinet 3 (control center 3). Under this assumption, the central unit U to which are connected the different cabinets 3, reprograms the latter for assigning them a new list of management modules 1.

The individual identification/authentication of each piece of equipment S upon connecting it onto a module 1 gives the possibility of very easily moving the pieces of equipment of a lamppost L to another one and thus reconfiguring a given service for adapting it to the needs of the urban community, simply by disconnecting and then reconnecting the piece of equipment S on the network plug (RJ45 or other plug), and then declaring the piece of equipment S at the new control center 3.

As an example, an IP camera installed at the top of the lamppost L intended for remote monitoring, for example of road traffic and/or security in the streets may be connected to the module.

Another example of an IP service is a surround sound system also positioned on the lamppost and allowing sound to be received on IP and to be broadcast on a loudspeaker.

Another IP service example is a Wifi terminal, giving the possibility of providing passer-bys with access to the Internet.

The suitable set of connections for these pieces of equipment is for example an RJ45 plug.

Another possibility is to connect to the module, a system for remote reading of meters (water, electricity, gas . . . ) which operates with radiofrequencies.

Thus, the management module gives the possibility of querying communicating meters located in its vicinity (for example by means of the Wavenis protocol), of sorting and storing the data given by the different meters, and of sending them back to the control center 3.

The suitable set of connections for the remote reading system is for example an RS232 plug. Of course, any other IP service may be connected to the management module.

The pieces of equipment are moreover selected so as to properly operate in a range of room temperatures comprised between −20 and +50° C.

Another further example is the recharging of an electric vehicle on recharging terminals integrated into the urban landscape at the feet of lampposts.

It will be noted, as regards the IP connection, that the management module 1 may only comprise one set of connections to an IP service. Indeed, as the lampposts are brought close to each other in a small town or on a road, it is not necessary that each of them bear a camera for remote monitoring, a loudspeaker for the sound system, etc. A distribution of the IP services may therefore be quite contemplated from among a set of adjacent lampposts. Typically, a camera every 30 to 100 lampposts, a speaker every 4 lampposts, a multimedia terminal every 10 lampposts are sufficient for meeting the needs of a small town.

It is obvious that the examples which have just been given are only particular, by no means limiting, illustrations as to the fields of application and to the functionalities of the invention.

1. A module for lamppost management connected to an electric power supply network, said module including electronics which comprises a power line carrier current injector/receiver through which it is connected to the electric network and which allows it to communicate with a control center for notably receiving instructions for switching on/off the lampposts,
said module is able to ensure management of at least one additional service and includes for this purpose:
at least two outputs capable of providing power independently to the lantern(s) of the lamppost and to at least one piece of service equipment associated with the lamppost,
at least one port for connecting a computer cable between this piece of equipment and said module,
the electronics being positioned in a casing capable of being integrated within the lamppost, on the lamppost or in proximity of the lamppost and including:
means capable of controlling independently the power supply outputs according to instructions transmitted by the carrier current by the control center,
means for processing and/or transmitting data connected to the port on the one hand and to the carrier current injector/receiver on the other hand, said carrier current injector/receiver being of the type with a high throughput.

2. The module according to claim 1, wherein the electronics includes:
a motherboard with a PLC injector/receiver which includes the data processing and transmitting means and which is connected to the port for connecting the computer cable, and
a daughterboard which includes means capable of controlling the power supply output, said daughterboard conversing with the motherboard having a PLC injector/receiver.

3. The module according to claim 1, said module including, added on the casing,
a first set of connections for a cable capable of ensuring the connection on the circuit breaker of the lamppost,
a set of power supply connections for a cable integrating at least two sheaths with two wires for the power supply independently of the lantern(s) of the lamppost and of a piece of service equipment,
a set of connections for an Ethernet connector cable.

4. The module according to claim 1, wherein the electronics further includes means for generating at least one output voltage for controlling the dimming of the lantern of a lamppost.

5. The module according to claim 4, wherein the electronics further includes means for generating at least one output voltage for controlling the dimming of the lantern of a lamppost, and the set of power supply connections is capable of receiving a cable further integrating the sheaths with power supply wires, at least one sheath with two wires receiving the dimming control voltage.

6. The module according to claim 1, wherein the electronics includes means for filtering EMC perturbations potentially generated by the ballasts of the lampposts.

7. The module according to claim 1, wherein the electronics includes means for measuring the individual consumption of the lantern(s) of the lamppost and/or of an associated piece of service equipment.

8. The module according to claim 7, wherein the data processing and transmission means include means for processing the measured individual consumptions and generating an alert signal intended for the control center when an abnormality is detected in the operation of the lantern(s) of the lamppost, of the service equipment and/or of the electric network.

9. The module according to claim 1, wherein it includes a memory for recording a timetable for switching on/off the lampposts and/or the services, transmitted to said module by the control center.

10. The module according to claim 1, wherein, for its integration inside the lampposts, the casing has a length of less than 500 mm, as well as a width and a height of less than 100 mm.

11. The module according to claim 1, wherein the injector/receiver also has a repeater function.

12. A system for telemanagement of public lighting, comprising a center for controlling a set of lampposts and at least one management module according to claim 1, installed in, on or in proximity to a lamppost and capable of ensuring independent management of the lighting of the lamppost and of at least one additional service, said module communicating with the control center through a high throughput power line carrier current.

13. The system according to claim 12, wherein the control center exchanges with a remote control unit of the network, said control unit including means for securely, transmitting IP data towards providers/users of services.

14. The system according to claim 12, wherein the control center is capable of detecting the connection of a new piece of service equipment on a module and includes means for querying said piece of equipment upon such a connection and transmitting to a control unit identification data compared by the control unit with data stored in memory in a database, in order to allow authentication of said equipment.
